(19) United States
(12) Patent Application Publication
(10) Pub. No.: US 2009/0122993 A1
(43) Pub. Date: May 14, 2009

(54) INFORMATION CAPTURING METHOD

(75) Inventor: MICHAEL G. HINCHEY, Bowie, MD (US)

Correspondence Address: NASA GODDARD SPACE FLIGHT CENTER, 8800 GREENBELT ROAD, MAIL CODE 140.1, GREENBELT, MD, 20771, US

(73) Assignee: U.S.A as represented by the Administrator of the National Aeronautics and Space Administrator, Washington, DC (US)

(21) Appl. No.: 11/937,777

(22) Filed: Nov. 9, 2007

(51) Int. Cl. H04H 40/00; H04H 60/00; H04H 20/00

(52) U.S. Cl. 381/2; 455/3.06; 381/150; 370/338

(57) ABSTRACT

A method for capturing information related to an audio signal includes broadcasting an acoustic signal capable of human perception, broadcasting an RF signal containing information related to content of the acoustic signal, receiving the acoustic signal, receiving the RF signal with a portable device, and using the portable device, storing the information related to the content of the acoustic signal. A similar method is used to capture information related to a visual display.

### ORIGIN OF INVENTION

The invention described herein was made by an employee of the United States Government, and may be manufactured and used by or for the Government for governmental purposes without the payment of any royalties thereon or therefore.

### FIELD OF THE INVENTION

The present invention relates to methods for identifying and storing information related to an audio broadcast or a visual display.

### BACKGROUND

In some areas frequented by humans, for example, restaurants, shopping malls, bars, taverns, medical complexes, office buildings, hotels, motels, airports, bus terminals, subway stations, etc., audio signals are broadcast. In even more areas, visual images, such as billboards or other advertisements, are displayed. The broadcast audio signals and the visual images can have one or more purposes, such as entertainment, amusement, general information, advertisement, etc.

In the case of audible music, the listener may often desire to know the name of a musical selection, the artist, and/or where the musical selection can be purchased or otherwise accessed. In the case of audio or visual advertisements, the listener may be interested in the product or service being advertised, but may forget how or where to contact the advertiser.

The Radio Broadcast Data System (RDS) is a known standard for sending small amounts of digital information using conventional FM radio broadcasts. The RDS system standardizes several types of information transmitted, including time, track/artist information and station identification. RDS uses a 57 kHz subcarrier to carry data at 1187.5 bits per second. Thus, if one is listening to FM radio music with a suitable FM receiver, one may be able to view the name of the artist and the musical selection on the display of the receiver. However, to obtain the RDS information, one must be tuned to an FM radio broadcast. Thus, in the case of acoustic signals or visual images, the RDS information is not available.

Some companies, such as AT&T, offer music identification services in conjunction with a mobile or wireless phone. In these services, one dials the service number and then holds the phone near a speaker for ten to fifteen seconds so that the service can record an audio clip. The service attempts to match the audio clip to a database of musical selections. If a match occurs, the service sends a text message with the name of the song and the artist to the user's mobile phone, in about a minute. Of course, these services are limited to music and further limited to the particular selections in the service's database. In addition, the audio quality must be sufficient to transmit over a mobile phone.

### SUMMARY

In one aspect, a method for identifying and storing information related to an audio broadcast includes broadcasting an acoustic signal capable of human perception, broadcasting an RF signal including information related to content of the acoustic signal, receiving the acoustic signal, receiving the RF signal with a portable device, and using the portable device, storing the information related to the content of the acoustic signal.

In another aspect, a method for identifying and storing information related to a visual display includes providing a visual display capable of human perception, broadcasting an RF signal including information related to content of the visual display, viewing the visual display, receiving the RF signal with a portable device, and using the portable device, storing the information related to the content of the visual display.

Further features and advantages of the invention will become apparent from the following detailed description taken in conjunction with the following drawings.

### BRIEF DESCRIPTION OF THE DRAWINGS

FIG. 1 is a schematic diagram illustrating a first embodiment of a method according to the invention.

FIG. 2 is a schematic diagram of an embodiment of a portable device for use with the method of the invention.

FIG. 3 is a schematic diagram illustration a second embodiment of a method according to the invention.

### DETAILED DESCRIPTION

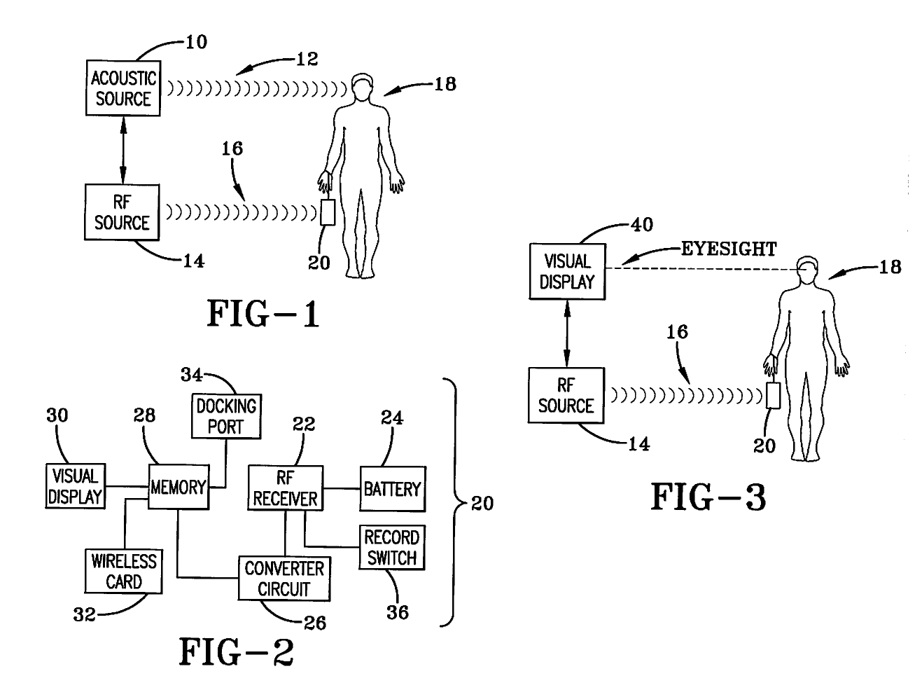

Referring to FIG. 1, an acoustic signal source 10 broadcasts an acoustic signal 12. The acoustic signal source 10 can be, for example, one or more speakers that transform electrical signals into acoustic signals. The acoustic signal source 10 can be located in a variety of areas, including but not limited to, restaurants, shopping malls, bars, taverns, medical complexes, office buildings, hotels, motels, airports, bus terminals, subway stations, etc. The acoustic signal 12 can include, for example, a musical selection or an advertisement.

A user, for example, human 18, receives the acoustic signal 12. The user 18 may desire more information related to the acoustic signal 12. For example, if the acoustic signal 12 includes a musical selection, the user may wish to know the title and/or artist of the musical selection or locations where the musical selection may be accessed or purchased. If the acoustic signal 12 includes an advertisement, the user may wish to know the contact information for the advertiser.

Simultaneously with the broadcasting of the acoustic signal 12, a radio frequency (RF) signal 16 is broadcast by an RF signal source 14 in the same vicinity as the acoustic signal 12. The RF signal 16 includes information related to the content of the acoustic signal 12. For example, the information in the RF signal 16 can include, but is not limited to, the name, artist, or place of purchase of a musical selection, a phone number, a mailing address, an email address, a URL, a website address, etc. The acoustic signal 12 and the RF signal 16 can be synchronized so that the information in the RF signal 16 corresponds to the particular acoustic signal 12 being broadcast.

The user 18 can be provided with a portable device 20 (FIG. 2) that includes an RF receiver for receiving the RF signal 16, a non-volatile memory 28 for storing the information in the RF signal 16, and a switch 36 for selectively recording the RF signal 16. When the user 18 hears a song or advertisement or other acoustic signal 12 and desires to record information related to acoustic signal 12, the user can switch the device 20 into the record mode. The device 20 can then record the RF signal 16 for a predetermined length of time. The predetermined length of time is, for example, a length of time sufficient to capture at least one complete cycle of the information in the RF signal 16. The device 20 can store the information from the RF signal 16 in a non-volatile memory 28.

FIG. 2 is a schematic drawing of one embodiment of the portable device 20. Device 20 includes an RF receiver 22 for receiving the RF signal 16, a record switch 36, a converter circuit 26 for converting the information in the RF signal 16 into a form suitable for storage, a non-volatile memory 28 and a battery 24. Device 20 can include a visual display 30 so that the user can immediately access the information in memory 28.

Device 20 can include a wireless card 32 so that the user can access the Internet to visit the URL or website stored in the memory 28. Device 20 can include a docking port 34 so that the device can be connected directly to the USB port of a computer, or indirectly to the USB port of a computer through a converter. Once connected to another computer, the contents of the memory 28 can be downloaded to the computer. Or, the memory 28 can be removable from the device 20 and, if the memory 28 is supplied with a USB port, the memory 28 can be directly connected to the USB port of a computer, or, if not supplied with a USB port, the memory 28 can be indirectly connected to the USB port of a computer through an appropriate converter.

In addition, device 20 can be integrated with another portable device, such as a mobile phone, an iPod®, a PDA, a Blackberry®, etc.

FIG. 3 is a schematic diagram illustrating another embodiment of a method according to the invention. A visual display 40, including but not limited to an advertisement, is provided in an area frequented by humans. An RF signal source 14 is located such that the RF signal 16 can be received by a user 18 who is viewing the visual display 40. The RF signal 16 includes information related to the content of the visual display 40. For example, the information in the RF signal 16 can include, but is not limited to, a phone number, a mailing address, an email address, a URL, a website address, etc. The RF signal 16 can be received and can be stored by a portable device 20, as described above with reference to FIGS. 1 and 2.

Although the above description may contain specific details, they should not be construed as limiting the claims in any way. Other configurations of the described embodiments of the invention are part of the scope of this invention. Accordingly, the appended claims and their legal equivalents should only define the invention, rather than any specific examples given.

What is claimed is:

1. A method for identifying and storing information related to an audio broadcast, comprising:
broadcasting an acoustic signal capable of human perception;
broadcasting an RF signal containing information related to content of the acoustic signal;
receiving the acoustic signal;
receiving the RF signal with a portable device; and
using the portable device, storing the information related to the content of the acoustic signal.

2. The method of claim 1, wherein broadcasting the acoustic signal and broadcasting the RF signal are performed simultaneously.

3. The method of claim 1, wherein receiving the acoustic signal and receiving the RF signal with a portable device are performed simultaneously.

4. The method of claim 1, further comprising:
viewing the information related to the content of the acoustic signal.

5. The method of claim 4, wherein the viewing is done with the portable device.

6. The method of claim 1, further comprising:
after storing the information, transferring the information to a second device.

7. The method of claim 6, wherein the second device includes an Internet connection.

8. The method of claim 1, wherein the acoustic signal comprises a musical selection.

9. The method of claim 8, wherein the information comprises at least one of music title and a music artist.

10. The method of claim 1, wherein the acoustic signal comprises an advertisement.

11. The method of claim 10, wherein the information comprises at least one of a phone number and a URL.

12. A method for identifying and storing information related to a visual display, comprising;
providing a visual display capable of human perception;
broadcasting an RF signal containing information related to content of the visual display;
viewing the visual display;
receiving the RF signal with a portable device; and
using the portable device, storing the information related to the content of the visual display.

13. The method of claim 12, wherein viewing the visual display and receiving the RF signal with a portable device are performed simultaneously.

14. The method of claim 12, further comprising:
viewing the information related to the content of the visual display.

15. The method of claim 14, wherein the viewing is done with the portable device.

16. The method of claim 12, further comprising:
after storing the information, transferring the information to a second device.

17. The method of claim 16, wherein the second device includes an Internet connection.

18. The method of claim 12, wherein the visual display comprises an advertisement.

19. The method of claim 18, wherein the information comprises at least one of a phone number and a URL.
